(19) United States
(12) Patent Application Publication
(10) Pub. No.: US 2006/0041747 A1
(43) Pub. Date: Feb. 23, 2006

(54) Encryption instruction processing apparatus

(76) Inventors: Yasuo Okumura, Osaka (JP); Kotaro Fukawa, Kyoto (JP)

Correspondence Address: MCDERMOTT WILL & EMERY LLP, 600 13TH STREET, N.W., WASHINGTON, DC, 20005-3096, US

(21) Appl. No.: 11/197,301

(22) Filed: Aug. 5, 2005

(30) Foreign Application Priority Data
Aug. 20, 2004 (JP) 2004-240952
Jul. 12, 2005 (JP) 2005-203637

(51) Int. Cl. H04L 9/00

(52) U.S. Cl. 713/168

(57) ABSTRACT

To provide an encryption instruction processing apparatus which makes it possible to reliably prevent fraud analysis of a program, encrypt only part of the program requiring protection so as to reduce a decryption time in a simple manner, and suppress increase in a hardware size, an encryption instruction processing apparatus is formed so that the apparatus includes an instruction decryption section and a decryption key storage section and decryption keys are stored in the encryption key storage section. Each of encryption extended instruction codes to be processed by the encryption instruction processing apparatus includes an instruction code and an instruction encryption identifier indicating whether or not the instruction code is encrypted. The instruction codes are encrypted according to the degree of confidentiality of each instruction code. In executing a program, according to a value for an instruction encryption identifier, the instruction decryption section decrypts an instruction code using the decryption key.

### CROSS REFERENCE TO RELATED APPLICATIONS

This non-provisional application claims priority under 35 U.S.C. § 119(a) on Patent Application No. 2004-240952 filed in Japan on Aug. 20, 2004, the entire contents of which are hereby incorporated by reference. The entire contents of Patent Application No. 2005-203637 filed in Japan on Jul. 12, 2005, are also incorporated by reference.

### BACKGROUND OF THE INVENTION

1. Field of the Invention

The present invention relates to an encryption instruction processing apparatus, such as a processor, which is incorporated into a so-called digital household electric appliance such as digital AV (audio video) equipment, a cellular phone (mobile communication equipment) and the like for dealing with digital data needing copyright protection and executes an encrypted instruction code.

2. Description of the Prior Art

In digital AV equipment or the like, digital data such as commercial video and music data of which copyright has to be protected is handled. To protect such digital data from unauthorized use and the like, for example, a technique for encrypting data in association with the format of a recording medium such as a DVD (digital versatile disk) and an SD memory card (secure digital memory card) for protection has been practically used.

However, in the case where encryption and decryption of data to be protected is performed by execution of a program, if processing procedures for the program execution is analyzed, the data can not be reliably protected. Therefore, in addition to protection of data to be protected by encryption, an encryption/decryption program itself has to be protected from being analyzed or the like.

As a technique for protecting a program from being analyzed or the like, there has been known a technique in which a program is encrypted beforehand and stored in a ROM, the encrypted program is decrypted by an instruction encryption decrypter disposed outside of a CPU and an instruction encryption key circuit, and then an instruction is executed in the CPU (for example, see Japanese Laid-Open Publication No. 62-171031, FIG. 1).

Moreover, in another technique for protecting a program from being analyzed or the like, part of a program on which confidentiality is imposed is encrypted and stored in an external memory and a loader for loading the program and decrypting the program and a memory management section are disposed. The decrypted program is written in a memory managed by the memory management section and then the instruction management section allows readout of the part decrypted only when the CPU executes an instruction, and memory management is performed so that readout of data as a whole is limited (for example, see Japanese Laid-Open publication No. 4-310128, FIG. 1).

Furthermore, there is still another technique in which memory management by a virtual memory mechanism is used and part of a program in which high confidentiality is imposed is encrypted for each page of the virtual memory mechanism (a size of 4 Kbytes or more in many processors) and stored in a memory, and a flag indicating whether or not encrypted part exists is added to the page table of the virtual memory mechanism, so that decryption of instruction to be executed is controlled (for example, see Japanese Laid-Open Publication No. 2001-230770, FIG. 1).

However, in a configuration in which an encrypted program is decrypted in an instruction encryption decrypter disposed outside of a CPU, it is easy to illicitly read out the program when the decrypted program is transmitted to the CPU. Therefore, protection of the program from fraud analysis and the like can not be ensured.

In the same manner, also in a configuration in which an encrypted program is decrypted in a loader disposed outside of a CPU and stored in a memory managed by a memory management section, it is easy to illicitly read out the decrypted program when the program is transmitted from the loader to the memory and when the program is transmitted from the memory to the CPU via a management section. Therefore, protection of the program from fraud analysis and the like can not be ensured. Furthermore, to limit readout of an instruction on which confidentiality is imposed from the memory as data, a memory management section is necessary. Accordingly, a problem of increase in a hardware size and fabrication cost arises.

Moreover, also in a configuration in which memory management by a virtual memory mechanism is used, a large hardware size is required. Therefore, if whether or not encrypted part exists is judged for each page of a memory managed by the virtual memory mechanism (4 Kbytes or more in many processors), precise setting for the presence and absence of encrypted part can not be achieved. Accordingly, part of a program which does not have to be encrypted is encrypted, so that with this unwanted encryption, an instruction execution speed is prone to be reduced.

### SUMMARY OF THE INVENTION

The present invention has been devised in view of the above-described problems, and therefore it is an object of the present invention to provide an encryption instruction processing apparatus which makes it possible to reliably prevent fraud analysis of a program, encrypt only part of the program requiring protection so as to reduce a decryption time in a simple manner, and suppress increase in a hardware size.

To solve the above-described problems, the present invention is directed to an encryption instruction processing apparatus for executing a program formed of a plurality of instruction codes including an encrypted instruction code and the apparatus is characterized by including: a read-in section for reading, with the instruction codes, instruction encryption information indicating whether or not each of the instruction codes is encrypted; and an instruction decryption section for decrypting, when the instruction encryption information indicates that at least one of the instruction codes is encrypted, the encrypted instruction code.

Thus, even if the program is formed so as to include both of an encrypted instruction code and an unencrypted instruction code, the encrypted instruction code is decrypted according to the instruction encryption information and then executed.

Moreover, according to one embodiment of the present invention, the inventive encryption instruction apparatus further includes a decryption key storage section for storing a plurality of decryption keys, the read-in section is formed so as to read, with the instruction codes, whether or not each of the instruction codes is encrypted and instruction encryption information indicating a decryption key to be used for decryption, and the instruction decryption section is formed so as to decrypt the encrypted instruction code using one of the decryption keys indicated by the instruction encryption information.

Thus, plural kinds of decryption keys can be flexibly used. That is, plural kinds of decryption keys are selectively used according to the instruction encryption information to decrypt at least an instruction code and execute the encryption code.

According to another embodiment of the present invention, the inventive encryption instruction apparatus is formed so that decryption keys having different sizes from one another are stored in the decryption key storage section.

Thus, decryption keys having different sizes from one another can be flexibly used. That is, decryption keys having different sizes from one another are selectively used according to the instruction encryption information to decrypt at least an instruction code and execute the encryption code.

According to another embodiment of the present invention, in the inventive encryption instruction processing apparatus, the read-in section is formed so as to read, with the instruction codes, whether or not each of the instruction codes is encrypted and instruction encryption information indicating an algorithm to be used for decryption, and the instruction decryption section is formed so as to decrypt the encrypted instruction code using the algorithm indicated by the instruction encryption information.

Thus, plural kinds of encryption algorithms can be flexibly used. That is, plural kinds of algorithms are selectively used according to the instruction encryption information to decrypt at least an instruction code and execute the encryption code.

According to another embodiment, in the inventive encryption instruction processing apparatus, the instruction codes are encryption AV processing instruction codes for performing encryption/decryption of AV contents and AV encoding/decoding, and in the program, at least one of the encryption AV processing instruction codes which does not require a real-time processing and requires high degree of confidentiality is encrypted and at least one of the encryption AV processing instruction codes which requires real-time processing and low level confidentiality is in an unencrypted form.

Thus, the range of decryption of instruction codes can be limited to at least one instruction code which does not require real-time processing and requires high degree of confidentiality, so that a decryption processing time for the instruction code is reduced. Accordingly, encryption/decryption of encryption AV contents and AV encoding/decoding can be performed at high speed.

### BRIEF DESCRIPTION OF THE DRAWINGS

FIG. 1 is a block diagram illustrating the configuration of an encryption instruction processing apparatus according to Embodiment 1 of the present invention.

FIG. 2 is a diagram illustrating the configuration of an encryption extended instruction code used in the encryption instruction processing apparatus of Embodiment 1 of the present invention.

FIG. 3 is a diagram illustrating an example of encryption of a program executed by the encryption instruction processing apparatus of Embodiment 1 of the present invention.

FIG. 4 is a block diagram illustrating the configuration of an encryption instruction processing apparatus according to Embodiment 2 of the present invention.

FIG. 5 is a diagram illustrating the configuration of an encryption extended instruction code used in the encryption instruction processing apparatus of Embodiment 2 of the present invention.

FIG. 6 is a diagram illustrating an example of encryption of a program executed by the encryption instruction processing apparatus of Embodiment 2 of the present invention.

FIG. 7 is a block diagram illustrating the configuration of an encryption instruction processing apparatus according to Embodiment 3 of the present invention.

FIG. 8 is a diagram illustrating the configuration of an encryption extended instruction code used in the encryption instruction processing apparatus of Embodiment 3 of the present invention.

FIG. 9 is a diagram illustrating an example of encryption of a program executed by the encryption instruction processing apparatus of Embodiment 3 of the present invention.

FIG. 10 is a block diagram illustrating the configuration of an encryption instruction processing apparatus according to Embodiment 4 of the present invention.

FIG. 11 is a diagram illustrating the configuration of an encryption extended instruction code used in the encryption instruction processing apparatus of Embodiment 4 of the present invention.

FIG. 12 is a diagram illustrating an example of encryption of a program executed by the encryption instruction processing apparatus of Embodiment 4 of the present invention.

FIG. 13 is a diagram illustrating an example of encryption of a program executed by the encryption instruction processing apparatus of Embodiment 5 of the present invention.

### DESCRIPTION OF THE PREFERRED EMBODIMENTS

Hereinafter, embodiments of the present invention will be described with reference to the accompanying drawings.

### Embodiment 1

Configuration of Encryption Instruction Processing Apparatus

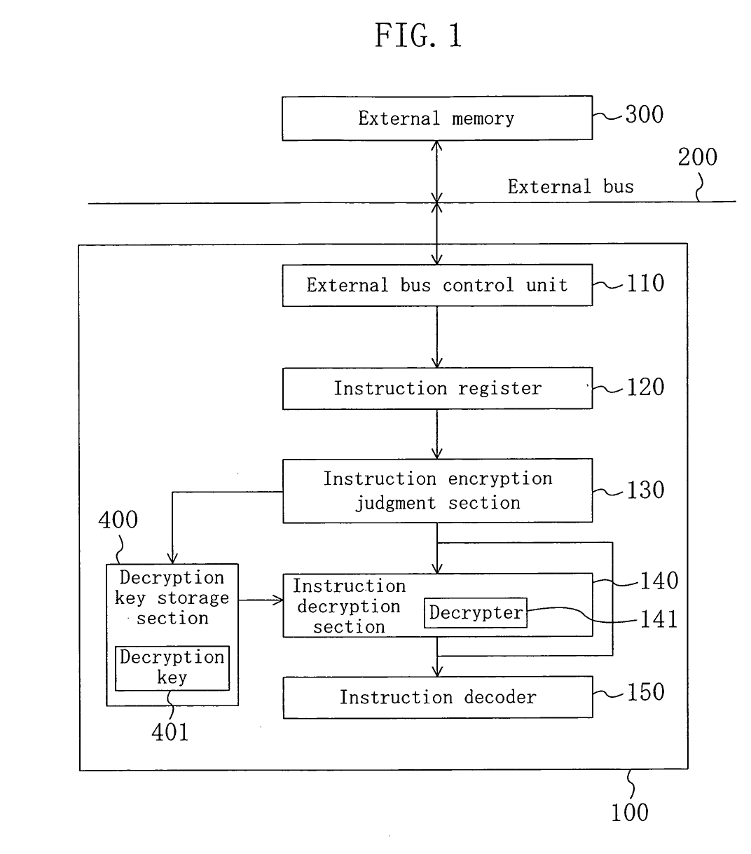

FIG. 1 is a block diagram illustrating the configuration of an encryption instruction processing apparatus according to Embodiment 1 of the present invention and an external memory 300 as a storage medium connected to the encryption instruction processing apparatus 100.

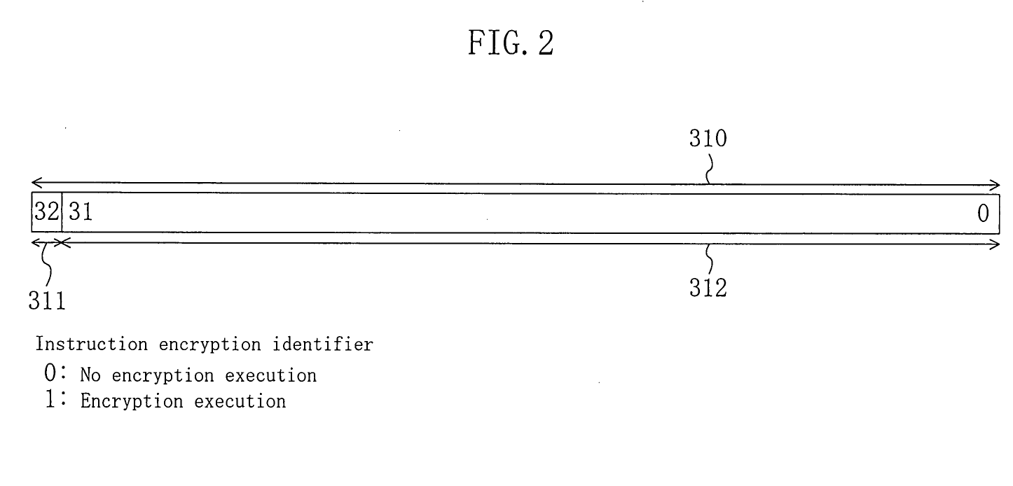

In the external memory 300, for example, as shown in FIG. 2, a program for processing data of which the copyright is to be protected and the like is stored. The program includes a plurality of encryption extended instruction codes 310 each having an instruction encryption identifier 311 and an instruction code 312. The instruction code 312 indicates an instruction to be actually executed by the encryption instruction processing apparatus 100. Encryption is performed in units of an instruction code 312 according to the degree of confidentiality of contents to be processed. Moreover, the instruction encryption identifier 311 is information indicating whether or not the instruction code 312 is encrypted. For example, if the instruction code 312 is not encrypted, the instruction encryption identifier 311 is set to be 0, and if the instruction code 312 is encrypted, the instruction encryption identifier 311 is set to be 1. In this case, various algorithms can be used as an encryption algorithm. An encryption algorithm used in this case is not particularly limited, for example, a DES encryption algorithm described in the following literature can be used. Shigeo Tujii and Masao Kasahara, Encryption and information security, Shoko-sha (ISBN4-7856-3057-2 C3055 P4326E).

The encryption instruction processing apparatus 100 for executing the above-described program will be specifically described.

The encryption instruction processing apparatus 100 includes an external bus control unit 110, an instruction register 120, an instruction encryption judgment section 130, an instruction decryption section 140, an instruction decoder 150 and a decryption key storage unit 400.

The external bus control unit 110 is connected to the external memory 300 via the external bus 200. The external bus control unit 110 reads out the encryption extended instruction codes 310 stored in the external memory 300 in order by controlling the external bus 200 and accessing the external memory 300 and outputs the encryption extended instruction codes 310 to the instruction register 120.

The instruction register 120 holds the encryption extended instruction codes 310 and outputs the encryption extended instruction codes 310 to the instruction encryption judgment section 130.

The instruction encryption judgment section 130 analyzes the instruction encryption identifier 311 of each of the encryption extended instruction codes 310 and outputs a signal (encryption judgment signal) in accordance with whether or not the instruction code 312 is encrypted to the decryption key storage section 400. If the instruction code 312 is encrypted, the instruction code 312 is output to the instruction decryption section 140, and if the instruction code 312 is not encrypted, the instruction code 312 is output to the instruction decoder 150.

The decryption key storage section 400 stores a decryption key 401 used for decrypting the encrypted instruction code 312, and the decryption key 401 is output to the instruction decryption section 140 according to the encryption judgment signal.

The instruction decryption section 140 includes a decrypter 141, decrypts the encrypted instruction code 312, and outputs the instruction code 312 to the instruction decoder 150.

According to an encryption judgment signal output from the instruction encryption judgment section 130, the instruction decoder 150 decodes the instruction code 312 decrypted by the instruction decryption section 140 or the instruction code 312, which is output by the instruction encryption judgment section 130 and is not encrypted, into a signal executable by an execution section (not shown) and then outputs the signal.

Operation of Encryption Instruction Processing Apparatus

Next, the operation of an encryption instruction processing apparatus formed so as to have the above-described configuration will be described. In this embodiment, the case where a program including an encryption extended instruction code 310 in which an instruction code 312 located from an address of (n+1) to an address of (n+4) is not encrypted and an encryption extended instruction code 310 in which an instruction code 312 located from an address of (n+6) to an address of (n+9) is encrypted is stored will be described.

When execution of in an address of n is started, a plurality of encryption extended instruction codes 310 are read out in order by the external bus control unit 110, stored in the instruction resistor 120 and output to the instruction encryption judgment section 130. In each of the encryption extended instruction codes 310, the instruction encryption identifier 311 is set as 0 (i.e., not encrypted) and thus the instruction encryption judgment section 130 outputs the instruction code 312 to the instruction decoder 150. Then, the instruction decoder 150 decodes the instruction code 312 and outputs the decoded instruction code 312 to the execution section. Then, the execution section executes the decoded instruction code 312.

When execution of the program shifts to an address of (n+5), the instruction encryption identifier 311 in the address of (n+5) is set to be 1. Thus, the instruction encryption judgment section 130 outputs, to the decryption key storage section 400, an encryption judgment signal indicating that the instruction code 312 is encrypted to make the instruction decryption section 140 output the decryption key 401, and furthermore outputs the instruction code 312 to the instruction decryption section 140. In the instruction decryption section 140, the decrypter 141 outputs the decrypted instruction code 312 to the instruction decoder 150 using the decryption key 401. The instruction decoder 150 decodes the decryption instruction code 312 and outputs the decoded decryption instruction code 312 to the execution section (not shown). Then, the execution section executes the decoded instruction code 312.

As described above, if decryption of an encrypted program and management of decryption keys are performed inside of an encryption instruction processing apparatus, the decrypted program, intermediate data during signal processing and decryption keys are not read from outside. Therefore, fraud analysis of the program can be prevented. Moreover, by allowing setting for the presence and absence in units of an instruction code of the program, only part of the program needing protection can be encrypted. Thus, even when it takes a long time for the decrypter 141 to process a signal, reduction in an execution speed can be suppressed.

Moreover, whether or not the instruction code 312 is encrypted can be judged only by analyzing a predetermined logic value (the instruction encryption identifier 311). Therefore, compared to the configuration in which a judgment method requiring a virtual memory mechanism and the memory management function, increase in a hardware size can be suppressed.

### Embodiment 2

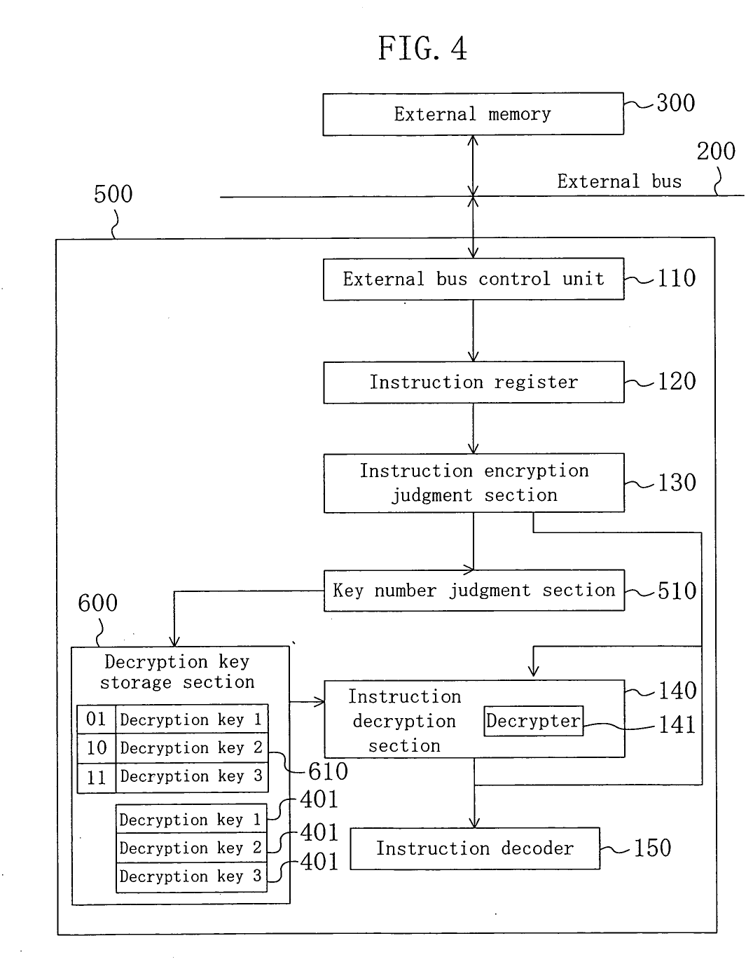

FIG. 4 is a block diagram illustrating the configuration of an encryption instruction processing apparatus 500 according to Embodiment 2 of the present invention. In this embodiment, each component having substantially the same function as that of Embodiment 1 is identified by the same reference numeral and therefore the description thereof will be omitted.

The encryption instruction processing apparatus 500 includes, instead of the decryption key storage section 400 of Embodiment 1, a decryption key storage section 600 shown in FIG. 4, and further includes a key number judgment section 510.

According to an encryption judgment signal input from the instruction encryption judgment section 130, the key number judgment section 510 outputs, to the decryption key storage section 600, a signal (key number identifying signal) corresponding to a key number identifier 321 included in an encryption extended instruction code 320 which will be later described.

Moreover, the decryption key storage section 600 stores a plurality of decryption keys such as decryption keys 1, 2 and 3 (i.e., decryption keys 401) and a decryption key table 610. The decryption key table 610 shows the correspondence relationship between the key number identifying signal and information indicating storage locations (for example, addresses) of the decryption keys 1, 2 and 3. One of the decryption keys 1, 2 and 3 corresponding to the key number identifying signal is output to the instruction decryption section 140.

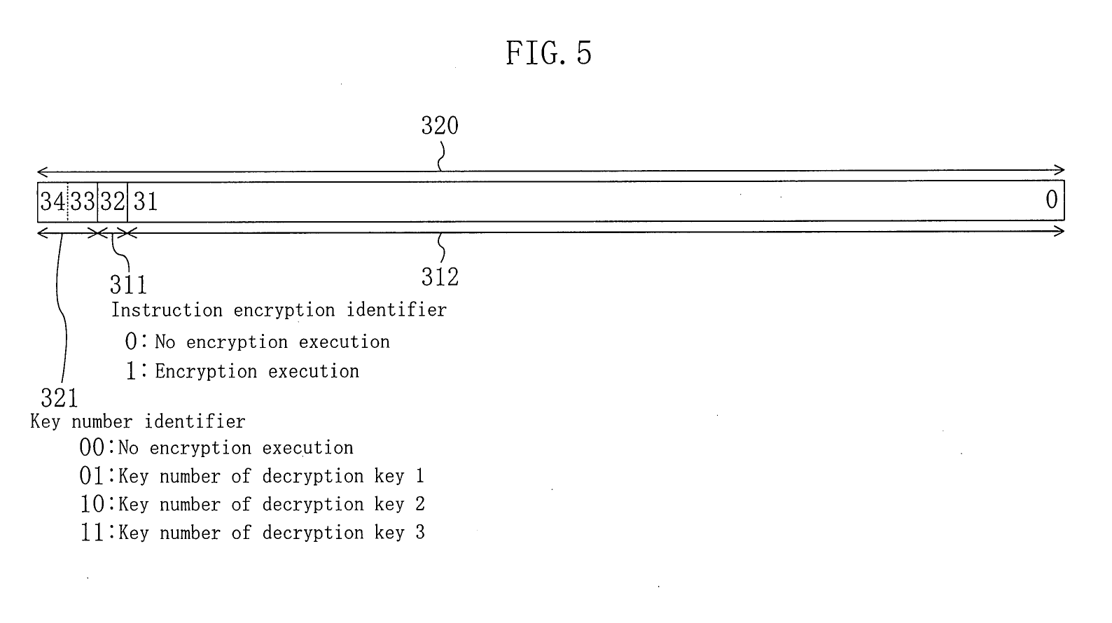

As shown in FIG. 5, a program to be executed by the encryption instruction processing apparatus 500 includes, for example, a plurality of encryption extended instruction codes 320 each having a key number identifier 321, an instruction encryption identifier 311 and an instruction code 312. When protection by encryption in accordance with the degree of confidentiality is needed, the instruction code 312 of each of the encryption extended instruction codes 320 is encrypted so as to be decryptable by one of the three decryption keys 401. Information indicating which decryption key is used to decrypt the instruction code 312 is set for the key number identifier 321. For example, when the instruction code 312 is decrypted by the decryption key 1, the key number identifier 321 is set to be 01. When the instruction code 312 is decrypted by the decryption key 2, the key number identifier 321 is set to be 10. And when the instruction code 312 is decrypted by the decryption key 3, the key number identifier 321 is set 00.

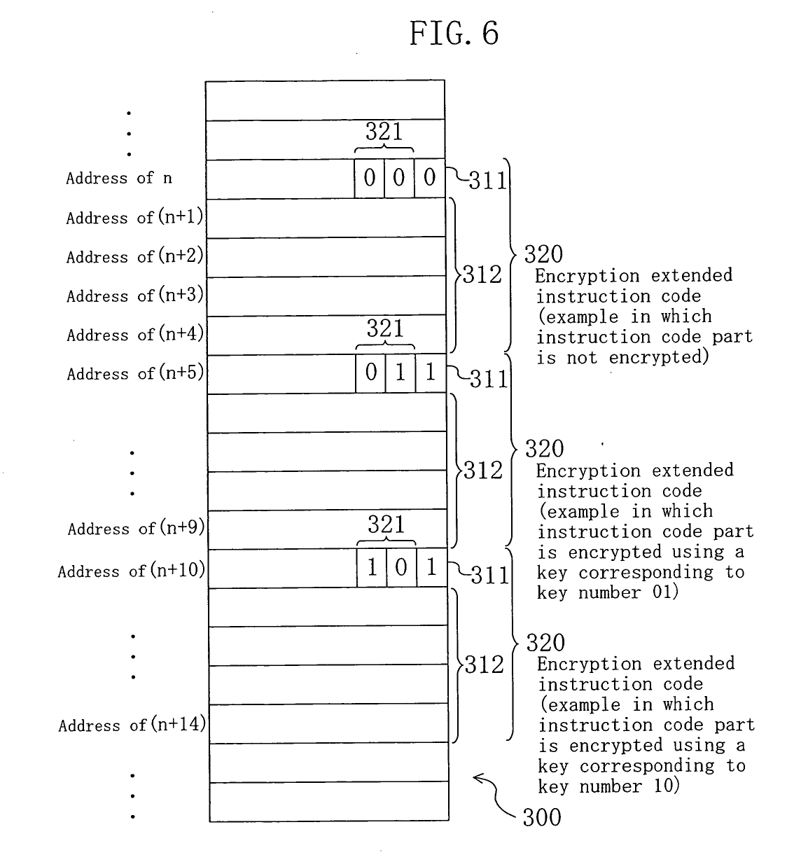

The operation of the encryption instruction processing apparatus 500 formed so as to have the above-described configuration will be described. For example, as shown in FIG. 6, the case where a program including an encryption extended instruction code 320 in which an instruction code 312 located from an address of (n+1) to an address of (n+4) is not encrypted, an encryption extended instruction code 320 in which the instruction code 312 located from an address of (n+6) to an address of (n+9) is encrypted so as to be decryptable by the decryption key 1, and an encryption extended instruction code 320 in which an instruction code 312 located from an address of (n+11) to an address of (n+14) is encrypted so as to be decryptable by the decryption key 2 is executed will be described.

The instruction code 312 in an address of (n+1) is not encrypted and therefore is executed in substantially the same operation manner as that of Embodiment 1. When execution of the program shifts to an address of (n+5), the instruction encryption identifier 311 is set to be 1 in the address of (n+5). Thus, the instruction encryption judgment section 130 outputs the instruction code 312 to the instruction decryption section 140 and the key number identifier 321 to the key number judgment section 510. Since the key number identifier 321 is set to be 01, the key number judgment section 510 outputs a key number identifying signal corresponding to the decryption key 1 to the decryption key storage section 600.

The decryption key storage section 600 obtains an address in which the decryption key 1 is stored using the key number identifying signal and the decryption key table 610 and outputs data of the read-out decryption key 1 to the instruction key storage section 140. In the instruction decryption section 140, the decrypter 141 outputs the decrypted instruction code 312 to the instruction decoder 150 using the decryption key 401. The instruction decoder 150 decodes the decrypted instruction code 312 and outputs the decoded instruction code 312 to an execution section. Then, the execution section executes the decoded instruction code 312.

In an address of (n+10), the instruction code 312 is decrypted using the decryption key 2 corresponding to the case where the key number identifier 321 is 10, so that an instruction shown by the decrypted instruction code 312 in the same manner as in the case of the address of (n+5) is executed.

As described above, in this embodiment, a plurality of decryption keys are stored inside of an encryption instruction processing apparatus and selectively used for each instruction code. Thus, protection of a program with a higher level of safety than that in Embodiment 1 can be achieved.

### Embodiment 3

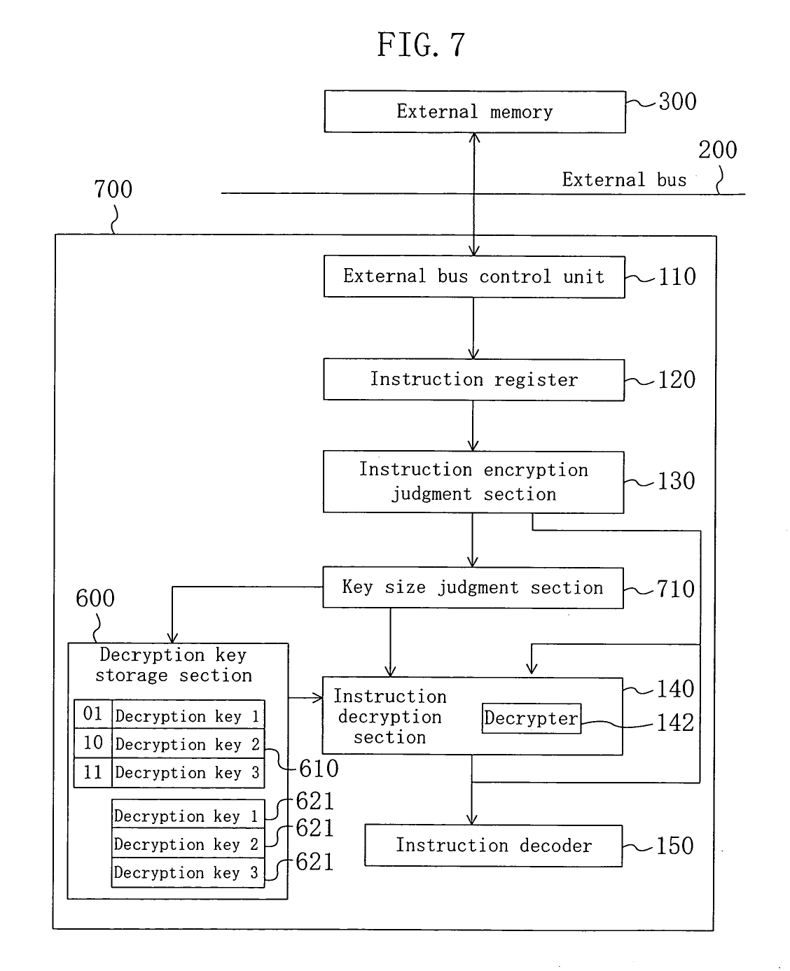

FIG. 7 is a block diagram illustrating the configuration of an encryption instruction processing apparatus 700 according to Embodiment 3 of the present invention.

The encryption instruction processing apparatus 700 includes, instead of the key number judgment section 510 of Embodiment 2, a key size judgment section 710 for outputting a signal (key size identifying signal) for identifying the size of a decryption key according to a value of the key size identifier 331 which will be described later. The decryption key storage section 600 holds decryption keys 621 having different sizes to one another and outputs one of the decryption keys 621 having a corresponding size to the key size identifier signal to the instruction decryption section 140. For example, the decryption key storage section 600 holds a decryption key 1 having a size of 128 bits, a decryption key 2 having a size of 192 bits and a decryption key 3 having a size of 256 bits as the decryption keys 621. Moreover, in the instruction decryption section 140, a decrypter 142 capable of performing decryption using any one of the decryption keys 1, 2 and 3 having different sizes is provided. As a decryption algorithm which can be used with decryption keys having different sizes, for example, AES encryption can be used. However, the decryption algorithm is not limited thereto, but some other algorithm using decryption keys having two or more different sizes can be used.

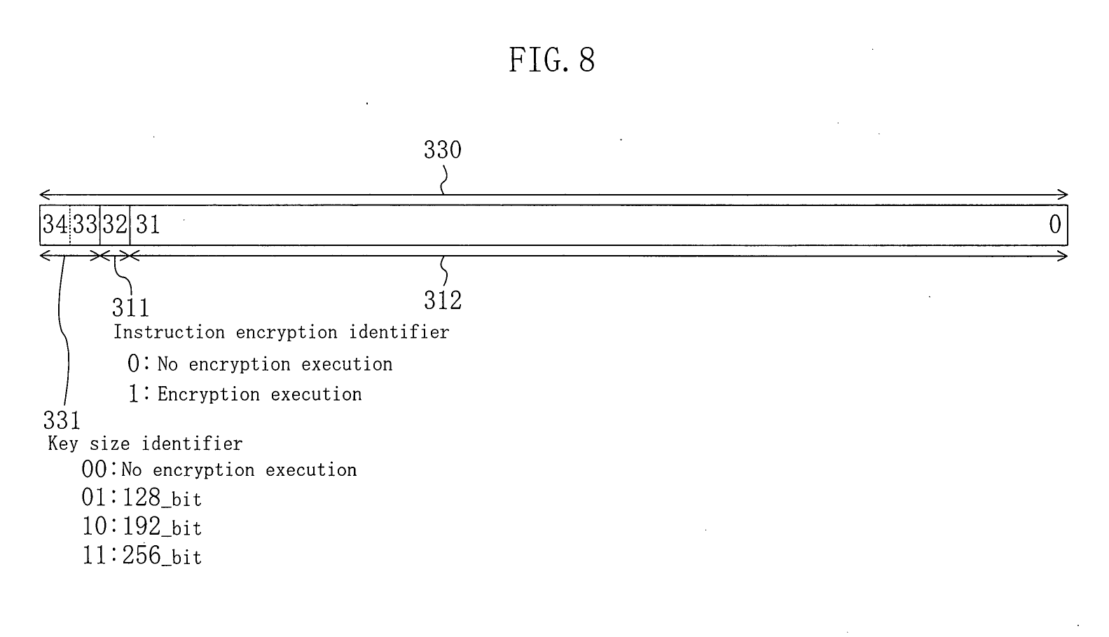

As shown in FIG. 8, a program executed by the encryption instruction processing apparatus 700 includes, for example, a plurality of encryption extended instruction codes 330 each having an instruction encryption identifier 311, an instruction code 312 and a key size identifier 331 provided as information indicating the size of an encryption key used in encrypting the instruction code 312 (i.e., the size of a decryption key used for decryption). That is, each instruction code 312 is encrypted using an encryption key having a size corresponding to the degree of confidentiality. Specifically, for example, the key size identifier 331 is set to be 01 when the decryption key 1 (128 bits) is used, the key size identifier 331 is set to be 10 when the decryption key 2 (192 bits) is used, and the key size identifier 331 is set to be 11 when the decryption key 3 (256 bits) us used.

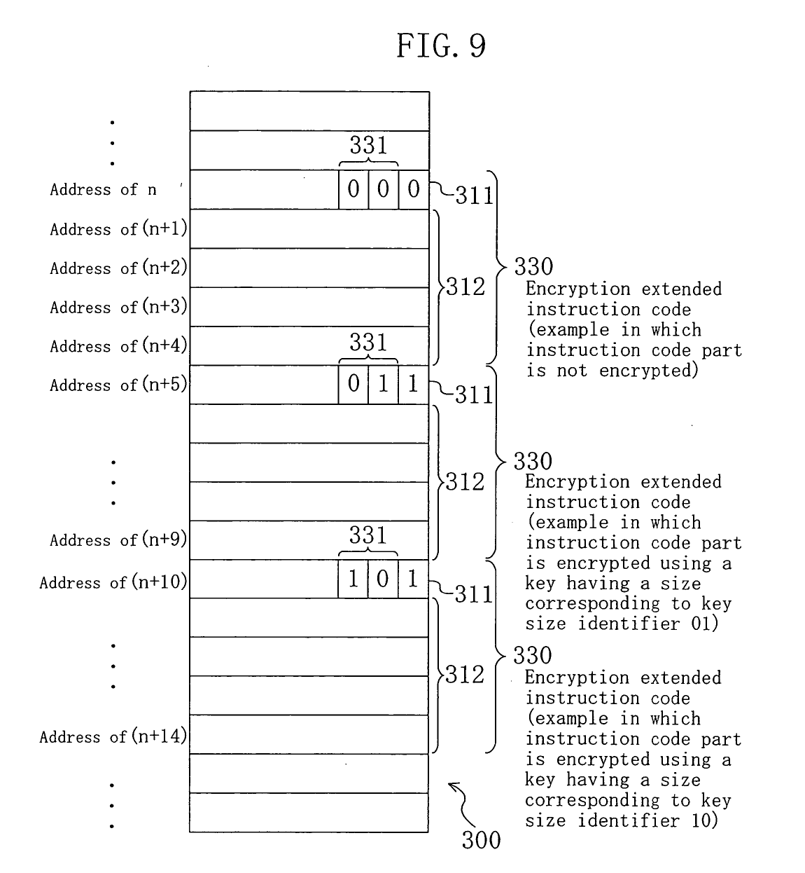

As shown in FIG. 9, the program including the above-described encryption extended instruction codes 330 is formed so as to include, for example, an encryption extended instruction code 330 in which an instruction code 312 located from an address of (n+1) to an address of (n+4) is not encrypted, an encryption extended instruction code 330 in which an instruction code 312 from an address of (n+6) to an address of (n+9) is encrypted by an encryption key corresponding to the encryption key 1 (128 bits), and an encryption extended instruction code 330 in which an instruction code 312 located from an address of (n+11) to an address of (n+14) is encrypted by an encryption key corresponding to the encryption key 2 (192 bits).

The operation of the processing unit is substantially the same as that of the processing unit of Embodiment 2. Specifically, as in Embodiment 2 in which an encryption key corresponding to a key number identifying signal is output from the decryption key storage section 600, an encryption key having a corresponding size to a key size identifying signal is output from the decryption key storage section 600 and decryption is performed by the decoder 142.

As described above, decryption keys having different sizes from one another are selectively used, so that, in addition to the same effects as those of Embodiment 2, both of confidentiality and execution speed can be maintained in a more simple manner.

### Embodiment 4

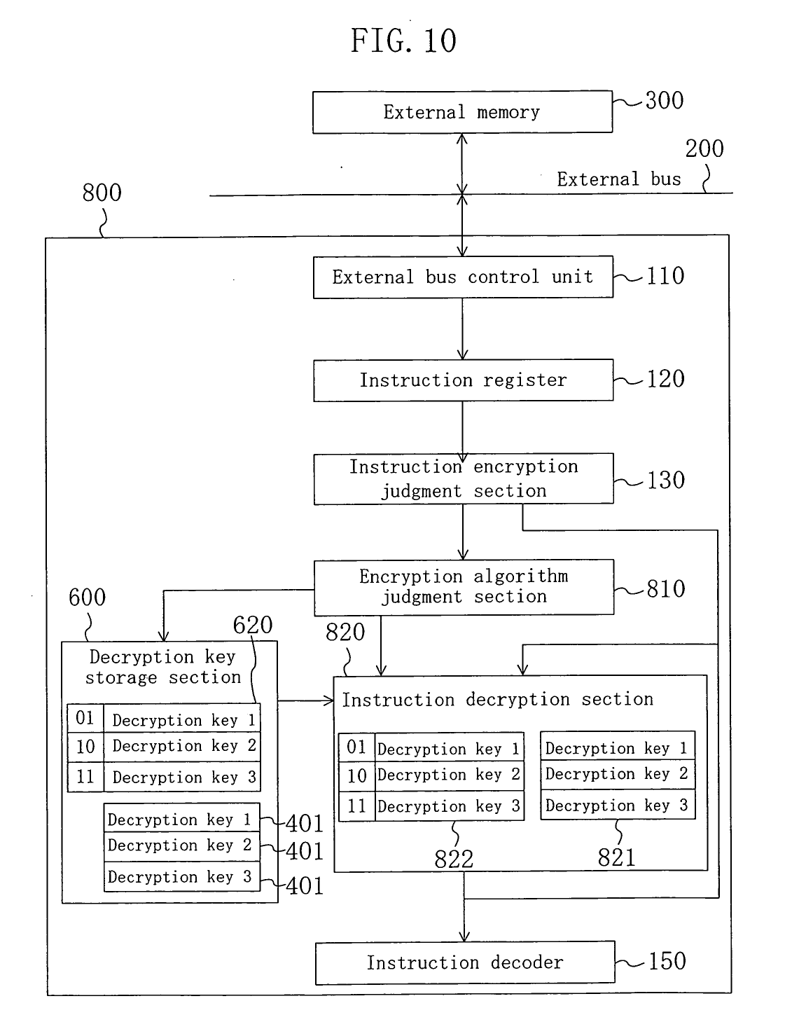

As shown in FIG. 10, an encryption instruction processing apparatus 800 according to Embodiment 4 of the present invention includes, instead of the key number judgment section 510 and the instruction decryption section 140 in Embodiment 2, an encryption algorithm judgment section 810 and an instruction decryption section 820. Moreover, the decryption key storage section 600 includes, instead of the decryption key table 610, a decryption key table 620.

The encryption algorithm judgment section 810 outputs a signal (encryption algorithm identifier signal) for identifying an encryption algorithm to a decryption key storage section 600 and an instruction decryption section 820 according to an encryption algorithm identifier 341 contained in an encryption extended instruction code 340 which will be described later.

The instruction decryption section 820 includes a plurality of decoders 821 (for example, a decrypter 1, i.e., a DES encryption decrypter, a decrypter 2, i.e., an AES encryption decrypter, and a decrypter 3, i.e., a triple DES encryption decrypter) and a decrypter table 822 indicating the correspondence relationship between each of the decrypters 821 and the encryption algorithm identifier signal. According to the encryption algorithm identifier signal, one of the plurality of decrypters 821 is selected to decrypt an instruction code 312 and the decrypted instruction code 312 is output to the instruction decoder 150. As an encryption algorithm used for each of the decrypters, for example, the following algorithms can be used: Federal Information Processing Standards Publication 197, Nov. 26, 2001, Announcing the ADVANCED ENCRYPTION STANDARD (AES), http://csrc.nist.gov/publications/fips/fips197/fips-197.pdf (Sep. 24, 2003); and FIPS PUB46-3, FEDERAL INFORMATION PROCESSING STANDARDS PUBLICATION, Reaffirmed Oct. 25, 1999, U.S. Department of Commerce/National Institute of Standards and Technology, DATA ENCRYPTION STANDARD (DES), http//cs-www.ncsl.nist.gov/publications/fips/fips46-3/fips46-3.pdf (Sep. 24, 2003)

Moreover, the decryption key storage section 600 includes the decryption table 620 which is similar to the decryption key table 610 of Embodiment 2. The decryption key storage section 600 outputs one of the plurality of decryption keys 1, 2 and 3 (decryption keys 401) corresponding to the encryption algorithm identifier signal to the instruction decryption section 820.

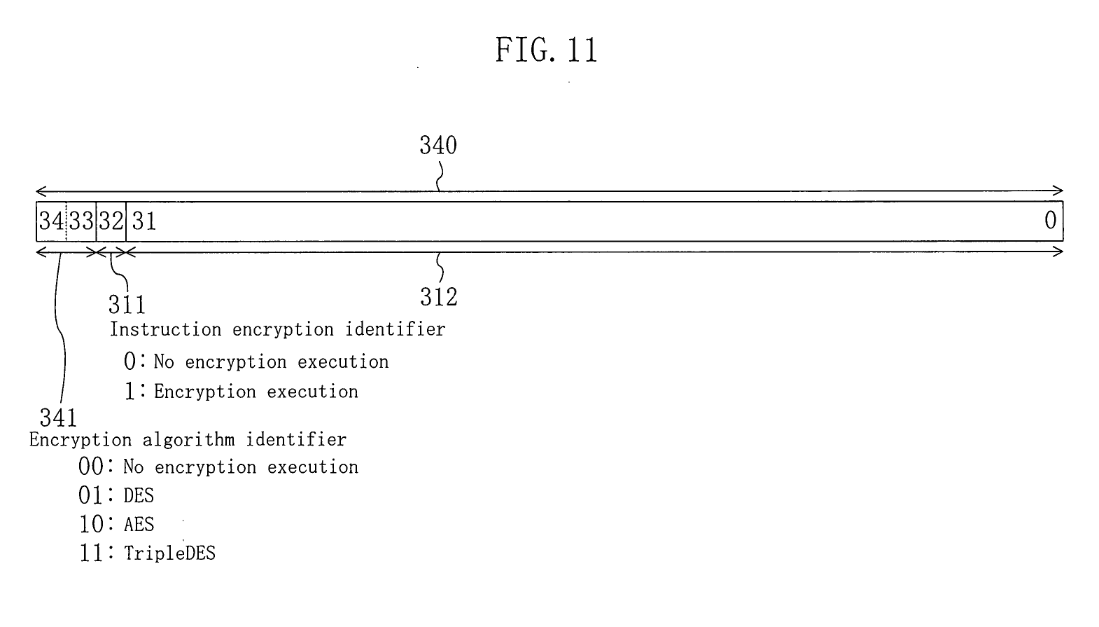

As shown in FIG. 11, a program executed by the encryption instruction processing apparatus 800 includes, for example, a plurality of encryption extended instruction codes 340 each having an encryption algorithm identifier 341, an instruction encryption identifier 311 and an instruction code 312. The instruction code 312 is encrypted according to the degree of confidentiality of the program so that each instruction code 312 can be decrypted by one of the plurality of decrypters 821 using one of the plurality of decryption keys 401.

In the encryption algorithm identifier 341, information indicating by which decryption algorithm (the decrypters 1, 2 and 3) the instruction code 312 is decrypted is stored. For example, the encryption algorithm identifier 341 is set to be 01 when the instruction code 312 is decrypted by the decrypter 2, the encryption algorithm identifier 341 is set to be 10 when the instruction code 312 is decrypted by the decrypter 3, and the instruction code 341 is set to be 00 when instruction code 312 is not decrypted.

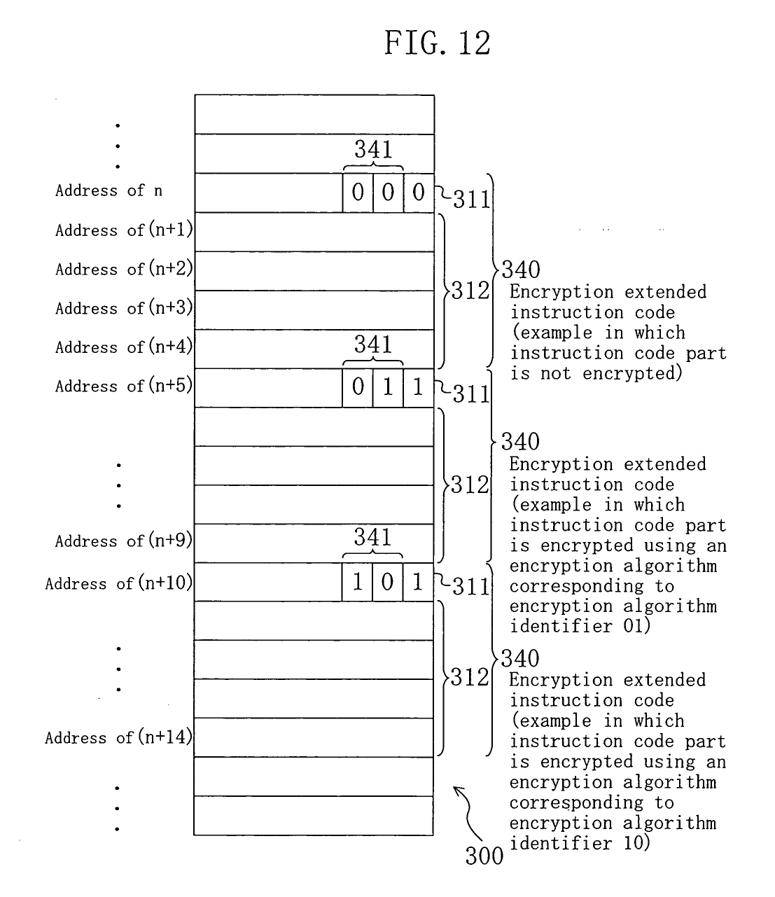

As shown in FIG. 12, the above-described program including the encryption extended instruction codes 340 is formed so as to include, for example, an encryption extended instruction code 340 in which an instruction code 312 located from an address of (n+1) to an address of (n+4) is not encrypted, an encryption extended instruction code 340 in which an instruction code 312 located from an address of (n+6) to an address of (n+9) is encrypted by the decrypter 1 (DES encryption decrypter) and an encryption key corresponding to the encryption key 1, and an encryption extended instruction code 340 in which an instruction code 312 located from an address of (n+11) to an address of (n+14) is encrypted by the decrypter 2 (AES encryption decrypter) and an encryption key corresponding to the encryption key 2.

In the encryption instruction processing apparatus according to Embodiment 4, a decrypter selected according to the encryption algorism identifier signal decrypts the instruction code 312 using a decryption key output from the decryption key storage section 600 according to the encryption algorithm identifier signal.

As described above, in this embodiment, a plurality of encryption algorithms are selectively used. Thus, in addition to the same effects as those of Embodiment 1, confidentiality and an execution speed can be achieved in a more simple manner. Moreover, if a particular encryption algorithm is illicitly analyzed by any chance, another encryption algorithm which is not illicitly analyzed can be used, so that program protection with higher operability can be realized, compared to the case where a decryption instruction processing apparatus using only a single encryption algorism.

### Embodiment 5

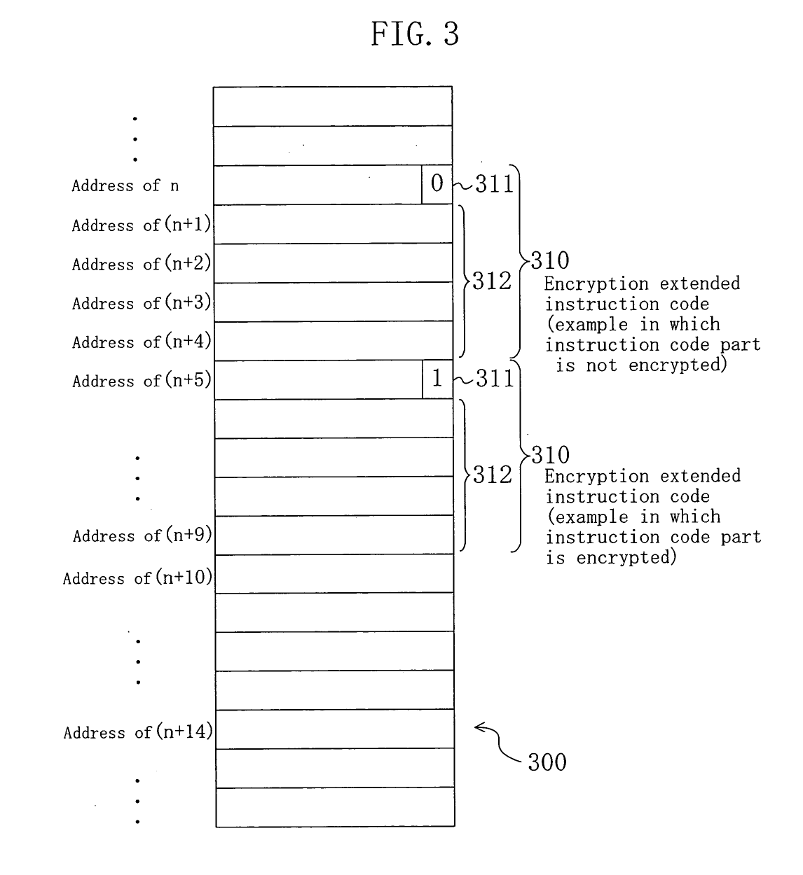

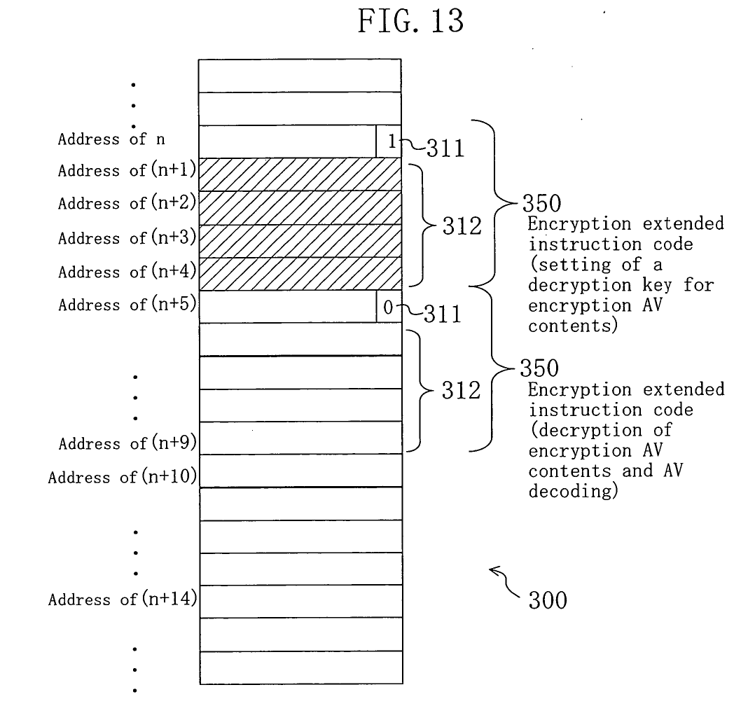

In the encryption instruction processing apparatus 100 of Embodiment 1, a program of FIG. 13 for performing decryption and decoding of encryption AV contents may be executed, instead of the encryption program of FIG. 3. The program of FIG. 13 for performing decryption and decoding of encryption AV contents includes a plurality of encryption extended instruction codes 350 each having an instruction encryption identifier 311 and an instruction code 312.

In decryption and decoding of encryption AV contents, instruction codes can be categorized into two types of instruction codes, i.e., a first type instruction codes which do not require real-time processing, require high degree of confidentiality and perform setting of decryption AV contents decryption key and a second type instruction codes which require real-time processing, require low level confidentiality and execute decryption of encryption AV contents and AV decoding. In an example shown in FIG. 13, an instruction code for performing setting of decryption AV contents decryption key is encrypted and stored from an address of n to an address of (n+4) in an external memory 300. Moreover, an instruction code for executing decryption of encryption AV contents and AV decoding is not encrypted and stored from an address of (n+5) to an address of (n+9) in the external memory 300.

When execution in the address of n in the program of FIG. 13 is started, with an instruction encryption identifier 311 set to be 1 in the address of n, the instruction encryption judgment section 130 outputs an encryption judgment signal indicating that the instruction code 312 is encrypted to a decryption key storage section 400 to make an instruction decryption section 140 output a decryption key 401. Furthermore, the instruction encryption judgment section 130 outputs the instruction code 312 to the instruction decryption section 140. In the instruction decryption section 140, a decrypter 141 outputs the decrypted instruction code 312 to an instruction decoder 150 using the decryption key 401. The instruction decoder 150 decodes the decrypted instruction code 312 and outputs the decoded instruction code 312 to an execution section (not shown). Then, the execution section executes the decoded instruction code 312. In this case, the decrypter 141 in the instruction decryption section 140 performs processing to decrypt the instruction code 312 using the decryption key 401. Accordingly, a processing time for this processing is larger than that of processing an instruction code of which an instruction encryption identifier is 0 and which is not encrypted. However, as the process of setting a decryption key for encryption AV contents, the above-described processing does not require a real-time processing and the number of executions is small. Therefore, no influence is given to decryption of encryption AV contents and real-time processing of AV decoding.

When execution in the address of (n+5) in the program is started, encryption extended instruction codes 310 are read out in order by an external bus control unit 110. The encryption extended instruction codes 310 are held in an instruction register 120 and then are output to the instruction encryption judgment section 130. In the encryption extended instruction codes 310, the instruction encryption identifier 311 is set to be 0 (i.e., not encrypted) and thus the instruction encryption judgment section 130 outputs the instruction code 312 to the decoder 150. The instruction decoder 150 decodes the instruction code 312 and outputs the decoded instruction code 312 to an execution section (not shown). Then, the execution section executes the decoded instruction code 312. In this case, decryption of the instruction code 312 by the decrypter 141 in the instruction decryption section 140 is not performed. Therefore, an instruction is executed at high speed and decryption of encryption AV contents and real-time processing of AV decoding become possible.

Note that, encryption, decryption algorithms, bit numbers of instruction encryption identifiers and key number identifiers, the correspondence relationship between each setting value and contents expressed by the setting value (encrypted or not, or distinction of keys), bit numbers of instruction codes and encryption extended instruction codes and the number of types of encryption algorithms, which have been described in the above-described embodiments are only examples and the present invention is not limited to the examples.

Moreover, in the above-described embodiments, whether or not an instruction code is encrypted is judged using an instruction encryption identifier. However, the present invention is not limited thereto. It may be judged, if values of a key number identifier and the like are set to be 00, that an instruction code is not encrypted.

In Embodiment 2, Embodiment 3, and Embodiment 4, examples in which using the key number identifier signal, the key size identifier signal and the like and tables such as the decryption key table 610, one of the plurality of decryption keys and one of the decrypters are selected have been described. However, the present invention is not limited thereto, but a key number identifier signal and a value for a key number identifier and the like may be decoded to select a decryption key and the like.

Moreover, in Embodiment 3, an example in which the sizes of decryption keys are different from one another has been described. However, decryption keys having the same size may be included.

Moreover, in Embodiment 4, an example in which each decrypter is selected in one-to-one correspondence with a decryption key has been described. However, for example, a decryption key and a decrypter may be independently selected so as to be in various combinations by assigning a key number identifier, a key size identifier and an encryption algorithm identifier according to an encryption extended instruction code.

Moreover, the number of decrypters to be provided does not have to be a plural number (i.e., the number of algorithms) and a decrypter capable of performing decryption using a plurality of different algorithms according to an algorithm identifier signal may be provided.

Moreover, Embodiment 5 describes an example in which as a program stored in the external memory 300, a program for performing decryption of encryption AV contents and AV decoding is used and the program is so configured that an instruction code which does not require a real-time processing, requires high degree of confidentiality and performs setting of an encryption AV contents decryption key is encrypted and an instruction code which requires real-time processing and low level confidentiality and executes decryption of encryption AV contents and AV decoding is not encrypted. However, for example, as a program stored in the external memory 300, a program for performing decoding of AV contents and encryption may be used and the program may be so configured that an instruction code which does not require real-time processing, requires high degree confidentiality and performs setting of an encryption key for AV contents is encrypted and an instruction code which requires real-time processing and low degree of confidentiality and executes encoding and encryption of AV contents does not have to be encrypted.

As has been described, in an encryption instruction processing apparatus according to the present invention, only part of a program requiring protection of the program is encrypted. Thus, the encryption instruction processing apparatus has the effect of preventing fraud analysis of the program, the effect of reducing a decrypting time and the effect of suppressing increase in a hardware size. Therefore, the encryption instruction processing apparatus of the present invention is useful as an encryption instruction processing apparatus or the like such as processor which is incorporated into a so-called digital household electric appliance such as digital AV (audio video) equipment, a cellular phone (mobile communication equipment) and the like and executes an encrypted instruction code.

What is claimed is:

1. An encryption instruction processing apparatus for executing a program formed of a plurality of instruction codes including an encrypted instruction code, the apparatus comprising:
a read-in section for reading, with the instruction codes, instruction encryption information indicating whether or not each of the instruction codes is encrypted; and
an instruction decryption section for decrypting, when the instruction encryption information indicates that at least one of the instruction codes is encrypted, the encrypted instruction code.

2. The encryption instruction apparatus of claim 1, further comprising a decryption key storage section for storing a plurality of decryption keys,
wherein the read-in section is formed so as to read, with the instruction codes, whether or not each of the instruction codes is encrypted and instruction encryption information indicating a decryption key to be used for decryption, and
wherein the instruction decryption section is formed so as to decrypt the encrypted instruction code using one of the decryption keys indicated by the instruction encryption information.

3. The encryption instruction apparatus of claim 2, wherein the apparatus is formed so that decryption keys having different sizes from one another are stored in the decryption key storage section.

4. The encryption instruction apparatus of claim 1, wherein the read-in section is formed so as to read, with the instruction codes, whether or not each of the instruction codes is encrypted and instruction encryption information indicating an algorithm to be used for decryption, and
wherein the instruction decryption section is formed so as to decrypt the encrypted instruction code using the algorithm indicated by the instruction encryption information.

5. The encryption instruction apparatus of claim 1, wherein the instruction codes are encryption AV processing instruction codes for performing encryption/decryption of AV contents and AV encoding/decoding, and
wherein in the program, at least one of the encryption AV processing instruction codes which does not require a real-time processing and requires high degree of confidentiality is encrypted and at least one of the encryption AV processing instruction codes which requires real-time processing and low level confidentiality is in an unencrypted form.
